(19) United States
(12) Patent Application Publication
(10) Pub. No.: US 2012/0158493 A1
(43) Pub. Date: Jun. 21, 2012

(54) ONLINE ADVERTISEMENT INVENTORY MANAGEMENT SYSTEM

(75) Inventors: Ramana Yerneni, Cupertino, CA (US); Thakur Vishwesh Singh, Sunnyvale, CA (US)

(73) Assignee: Yahoo! Inc., Sunnyvale, CA (US)

(21) Appl. No.: 12/970,505

(22) Filed: Dec. 16, 2010

(51) Int. Cl. G06Q 30/00

(52) U.S. Cl. 705/14.49

(57) ABSTRACT

A network based advertisement system includes an advertisement admission system configured to receive target values that belong to different target categories and to generate a search query associated with the target values and target categories. The system includes a supply forecasting system configured to select sample opportunities that match the search query from a store of opportunities. The advertisement admission system then determines one or more target value combinations. Each target value combination includes at least one target value from each of the different target categories. Then, the advertisement admission system determines a number of available opportunities represented by the sample opportunities that match the one or more target value combinations.

### BACKGROUND

The Internet has emerged as a powerful advertising tool. It is commonplace to see advertisements on many web sites. For example, advertisements may be displayed on search web sites and may be targeted to individuals based upon search terms provided by the individuals. Other web sites, such as news and sports web sites, may provide space for advertisements. The owners of these web sites may sell advertising space to advertisers to offset the costs associated with operating the web sites as well as to turn a profit.

To place an advertisement, an advertiser may enter into a contract with a publisher that operates an ad serving system to serve a number of advertisement impressions. An impression corresponds to the display of an advertisement to a user. For example, the advertiser may purchase 10,000 impressions for $100 and may specify a particular target audience, such as users that like sports.

When preparing to enter a contract, the advertiser may initially navigate to a web page for specifying target audience information where the advertiser may enter target values for various target value categories. The target values of the various target value categories may be combined into a bulk query that is subsequently communicated to a system configured to determine an amount of available impression inventory that matches the bulk query. In particular, the system may be configured to extract various sub-combinations of target values from the bulk query and determine an amount of available impression inventory that matches each sub-combination.

In some instances, however, the advertiser does not have a specific target audience in mind and is more interested in obtaining inventory information for a large landscape of target values. In such a case, the advertiser may specify many target value combinations. The large number of target value combinations results in a correspondingly large bulk query that yields many sub-combinations of target values. Obtaining accurate inventory information associated with such a bulk query can be time consuming (e.g., several minutes) and processor intensive.

### BRIEF DESCRIPTION OF THE DRAWINGS

FIG. 1 is an exemplary inventory management system for booking advertisements;

FIG. 2 is an exemplary web page that may be communicated to an advertiser to enable the specification of advertisement target information;

FIG. 3 is an exemplary result web page that may be communicated to the advertiser;

FIG. 4 illustrates exemplary information that may be stored in a campaign log database;

FIG. 5 illustrates exemplary information that may be stored in an ad log database;

FIG. 6 illustrates exemplary operations performed by an inventory management system;

FIG. 7 illustrates exemplary samples that match a bulk query;

FIG. 8 is an exemplary graph that illustrates the allocation of opportunities from opportunity samples to existing advertisement contracts;

FIG. 9 is an exemplary graph that illustrates the allocation of available opportunities from opportunity samples to target value combinations; and

FIG. 10 illustrates a general computer system that may represent any of the computing devices referenced herein.

### DETAILED DESCRIPTION

The embodiments below describe an exemplary embodiment of a system for booking and serving advertisements. In particular, the system is configured to enable advertisers to specify a bulk query specifying many target values. Rather than provide an accurate estimate for each sub-combination of target values, which can be time-consuming and/or processor intensive for a large bulk query, the system instead returns a somewhat coarse representation of the amount of available inventory for various sub-combinations of target values of the bulk query. The system then communicates the coarse representation of available inventory to the advertiser who may then select specific target value combinations for which more accurate information is desired. The system then processes the selected sub-combination to obtain a more accurate estimate for the selected sub-combination of target values.

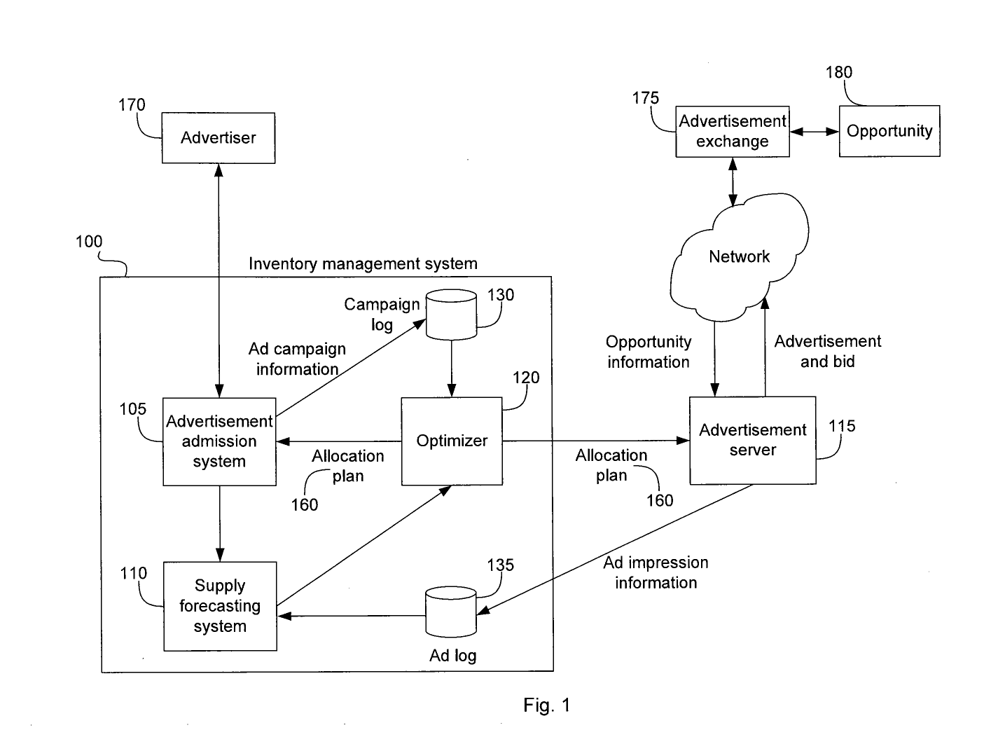

FIG. 1 is an exemplary inventory management system 100 for booking advertisements. The system 100 includes an advertisement admission system (AAS) 105, a supply forecasting system 110, and an optimizer module 120. Also shown are an advertisement server 115 (ad server) that in some implementations is part of the inventory management system 100. The various components of the system 100 may reside on a single computer system or be distributed among several computers interconnected by a communication network.

The AAS 105, supply forecasting system 110, ad server 115, and optimizer 120 may correspond to an Intel®, AMD®, or PowerPC® based computer or a different computer. The AAS 105, supply forecasting system 110, ad server 115, and optimizer 120 may include an operating system, such as a Microsoft Windows®, Linux, or other Unix® based operating system. The AAS 105, supply forecasting system 110, ad server 115, and optimizer 120 may be configured to communicate with other computers via an interface, such as a network interface.

The advertisement admission system (AAS) 105 includes code, logic, and/or other circuitry that enables advertisers 170 to enter into a contract with an advertisement network operator that operates the system 100 for the delivery of web-based advertisements. In some instances, the advertisement network operator may also correspond to a web site publisher that publishes web pages upon which advertisements are shown. The AAS 105 may communicate a web page to the advertiser 170 that enables the advertiser 170 to open an account with the publisher and provide information for setting up an advertisement campaign. The web page may enable the advertiser 170 to upload an advertisement creative, such as the graphics of an advertisement. The web page may also enable the advertiser 170 to specify advertisement information that defines the circumstances under which an advertisement is to be communicated to an opportunity (i.e., a user).

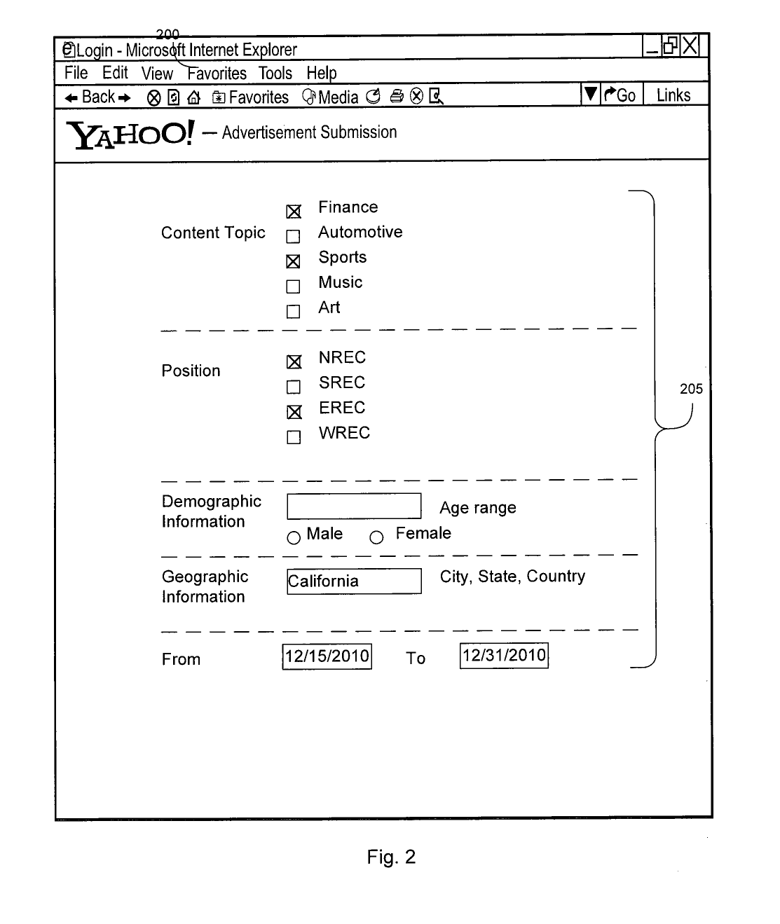

FIG. 2 is an exemplary web page 200 that may be communicated to an advertiser 170 (FIG. 1) to enable the specification of advertisement target information. The web page 200 may include target fields 205 that enable specifying the target values associated with different target categories. Exemplary target categories include content topic, property, demographic, geographic, date range, and other target categories. The target fields 205 may include fields for specifying a web page content topic such as finance, automotive, sports, music, art, a hobby or other content topic. The target fields 205 may include fields for specifying a property upon which an advertisement is to be displayed, such as Yahoo! finance, sports, music web page, or a different web page. The target fields 205 may include fields for specifying demographic information, such as an age range and gender of a target audience. The target fields 205 may include fields for specifying geographic information such as a city, state, or country of a target audience. The target fields 205 may include fields for specifying a date range within which to deliver an advertisement. Other target fields may be provided for specifying different target values.

Some advertisers 170 may not have a particular target audience in mind. Rather, these advertisers 170 may be interested in ascertaining the general landscape of available opportunities, where an opportunity corresponds to an instance of a user viewing a web page configured to display one or more advertisements. The advertisers 170 may specify several target values from each of several different target categories.

After specifying the target values, a bulk query that encapsulates the target values may be generated by the AAS 105 and communicated to the supply forecasting system 110. An exemplary bulk query may be represented as follows:

| | |
|---|---|
| Bulk query= | Content topic (Sports, Finance); |
| | Position = (NREC, EREC); |
| | Location = CA; |
| | Date range = December 15, 2010 - December 31, 2010 |

The bulk query may be divided into target categories (e.g., content topic, position, location, date range, etc.). The corresponding target values associated with each target category may also be provided. The bulk query is configured to be communicated to the supply forecasting system 100. The bulk query is configured so that the supply forecasting system 110 will select sample opportunities that match any combination of target values in the respective target categories. For example, given the bulk query above, samples returned may match the following combinations:
(Content topic=Sports, Position=NREC, Location=CA, Date range=Dec. 16, 2010),
(Content topic=Finance, Position=NREC, Location=CA, Date range=Dec. 20, 2010),
(Content topic=Sports, Position=EREC, Location=CA, Date range=Dec. 18, 2010),
(Content topic=Finance, Position=NREC, Location=CA, Date range=Dec. 16, 2010)
The samples returned by the supply forecasting system 110 are then analyzed by the AAS 105 to determine a number of available opportunities. The AAS 105 may communicate the results to the advertiser 170 via a result web page.

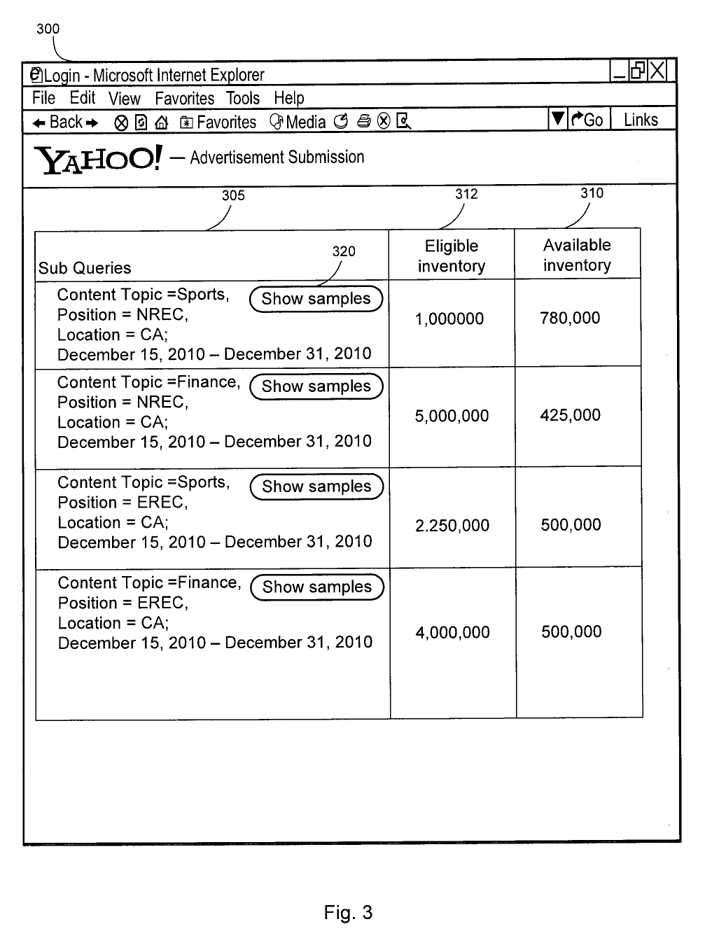

FIG. 3 is an exemplary result web page 300 that may be communicated to the advertiser 170. The exemplary web page 300 includes a table with a sub-query column 305, an eligible inventory column 312, and an available inventory column 310. The sub-query column 305 includes one or more target value combinations associated with the bulk query specified above. Each target value combination corresponds to a different combination of target values of the different target categories of target values. Stated differently, the sub-queries represent the various combinations of target values specified in the bulk query.

The eligible inventory column 312 lists an eligible amount of opportunity inventory available that matches the associated sub-query. Not all the eligible inventory, however, may be available. That is, some of the eligible inventory may already be allocated to existing contract.

In some implementations, the available inventory column 310 lists a coarse estimate of the number of available opportunities that match the associated sub-query (i.e., a coarse estimate of the available inventory). In other implementations, the available inventory column 310 lists an accurate representation of the available inventory for a given sub-query when the number of sub-query combinations is below a threshold (e.g., 10 sub-queries), and a coarse estimate of the available inventory when the number of sub-query combinations is greater than or equal to the threshold.

In some implementations, the result web page 300 may be configured to enable the advertiser to view one or more opportunity samples that match a given sub-query. For example, a button 320 or link may be configured to communicate opportunity samples associated with a given sub-query. The opportunity samples may include characteristics that match the various target values of the target categories for the sub-query, such as the content topic, position, geographic location, and date range shown in the exemplary result web page 300. Other characteristics not specifically targeted may also be shown. For example, the gender associated with the opportunity, age, hobbies, etc. may also be communicated. This feature enables the advertiser to get a better understanding of the actual opportunities to which an advertisement may be communicated should the sub-query be specified.

The result web page 300 enables the advertiser to quickly ascertain the eligible inventory and an approximate amount of available inventory for the various sub-queries derived from the original bulk query. The combination of eligible and available inventory enables the advertiser to identify opportunities that may be in higher demand. In some implementations, the result web page 300 is configured so that the advertiser may select one or more of the listed sub queries. A more accurate accounting of the available inventory associated with the selected sub queries may then be determined and communicated to the advertiser.

Returning to FIG. 1, AAS 105 may communicate additional web pages (not shown) that enable the advertiser to book the opportunities viewed above. Information that defines a contract associated with the booking may be stored to a campaign log database 130.

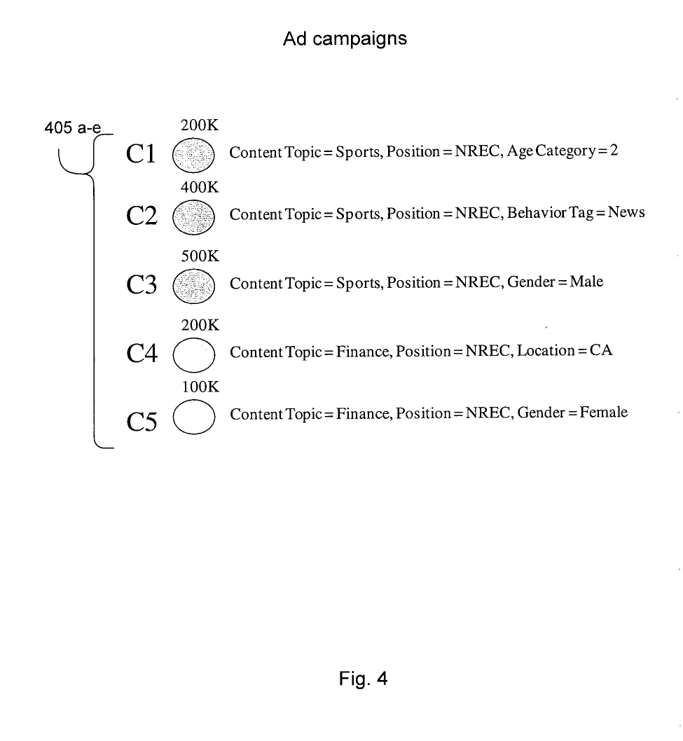

FIG. 4 illustrates exemplary information that may be stored in the campaign log database 130. Referring to FIG. 4, the campaign log database 130 stores information associated with various contracts (e.g., C1-C5) 405a-e. For each contract 405a-e, target information that defines the booked opportunities is specified. A number of opportunities booked for each contract 405a-e may be specified for each contract 405a-e. For example, 200,000 opportunities may be allocated to contract C1 405a. 400,000 opportunities may be allocated to contract C2 405b and so on. Other information associated with the various contracts 405a-e may be stored. The number of contracts shown is for illustration purposes. The actual number of stored contracts could number in the thousands or tens of thousands of contracts.

Returning to FIG. 1, the optimizer 120 includes code, logic, and/or circuitry that enables the generation of an allocation plan 160. The optimizer 120 is configured to communicate the allocation plan 160 to the ad server 115 and the AAS 105. The allocation plan generated by the optimizer 120 may be updated on a periodic basis, such as every few hours, so that the plan takes into consideration new estimates for supply, demand, and delivered impressions.

The allocation plan 160 defines statistical information that controls the way in which the ad server 175 matches contracts to opportunities. For example, the allocation plan 160 may instruct the ad server 115 to match contracts according to certain performance objectives. U.S. patent application Ser. No. 12/871,340, filed Aug. 30, 2010, describes methods and systems for generating such performance objectives and is hereby incorporated by reference.

The allocation plan 160 also provides instructions to the AAS 105 regarding available inventory and an amount to charge for the inventory. For example, the allocation plan 160 may specify an amount of impression inventory available that targets a particular target audience. The allocation plan 160 may also specify an amount to charge for impressions purchased from the available inventory. The AAS 105 may communicate the number of available impressions and the purchase price for the impressions to an advertiser 170 during ad submission.

The supply forecasting system 110 includes code, logic, and/or circuitry that enables forecasting an amount of inventory or opportunities available at a future date or date range based on previously served opportunities. The previously served opportunities correspond to those impressions represented in the ad log database 135. The determination of the size and make-up of the future opportunity inventory is statistical in nature in that there is no guarantee that a particular opportunity will actually present itself in the future. However, the likelihood that an opportunity will arise on a certain date (i.e., that a user with certain characteristics will visit a web page) increases if similar opportunities had arrived in the past. Given that the number of impressions that may be represented in the ad log data base 135 could number in the millions per day range, the supply forecasting system 110 is configured to forecast the available inventory based on impression samples rather than all the impressions represented in the ad log database 135.

In operation, the supply forecasting system 110 receives one or more inventory search queries and determines the number of opportunities that match the queries based on the number of sample opportunities (i.e., impressions) stored in the ad log data base 135 that match the inventory queries, and a weight associated with each sample. The weight corresponds to the number of impressions in the ad log data base 135 that match the sample opportunity. The total inventory of opportunities for a query is the sum of the weights of the samples that match the query.

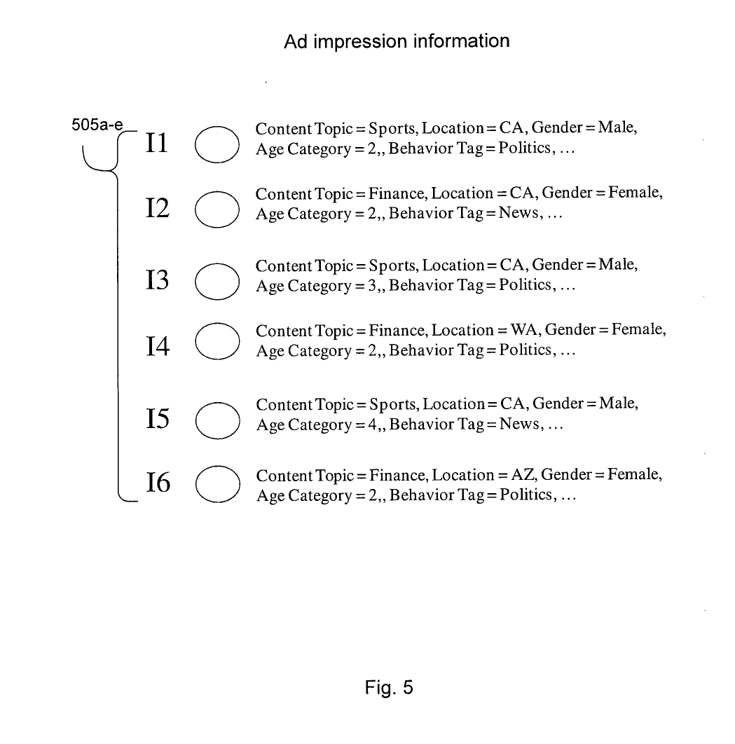

FIG. 5 illustrates exemplary information that may be stored in the ad log database 135. The information stored may include information that defines millions of impressions of which a few exemplary impressions 505a-e are shown. An impression 505a-e corresponds to the display or delivery of an advertisement to a user. Each impression 505a-e corresponds to an advertisement communicated to a user viewing a web page. The impression 505a-e may include data that defines the web page through which the advertisement was communicated. For example, the impression 505a-e may include the web page content type (e.g., sports, finance, etc.). The web page may include various regions set aside for the display of advertisements. These regions are referred to as positions, such as North, South, East and West, which correspond to the top, bottom, left, and right regions, respectively, of the web page. Other regions and means for describing the regions may be provided in the information. Accordingly, each impression 505a-e may include information that defines the region of the web page associate with the impression 505a-e. In this regard, a single web page with multiple advertisement regions is capable of delivering a corresponding number of impressions 505a-e at once.

Each impression 505a-e also includes to the extent possible demographic information that characterizes the user that viewed the web page. For example, the age, gender, etc., of the user may be specified. This information may be determined based on identifying information (e.g., a cookie) communicated from the user's browser. The identifying information may be uniquely associated with the user and may enable tracking the user's habits.

Other information may include geographic information that describes the location where the advertisement was viewed, such as a city, state, zip code, etc. This information may be known based on the identifying information above or may be determined via other means, such as by determining the geographic location based on an Internet Protocol (IP) address associated with the user's browser.

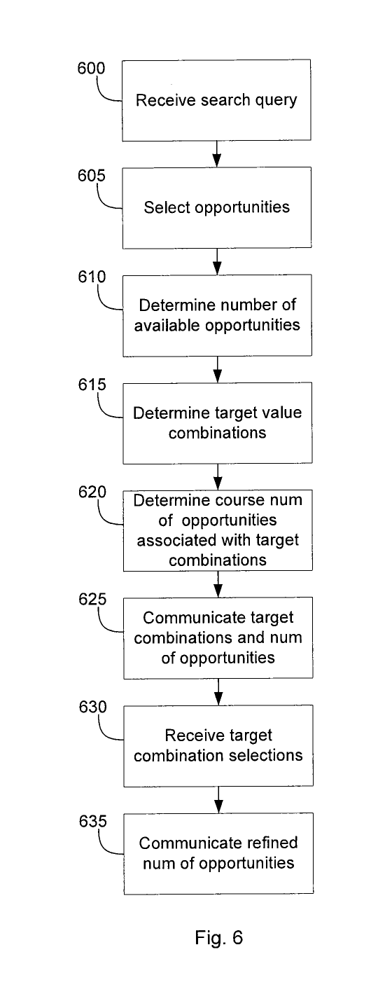

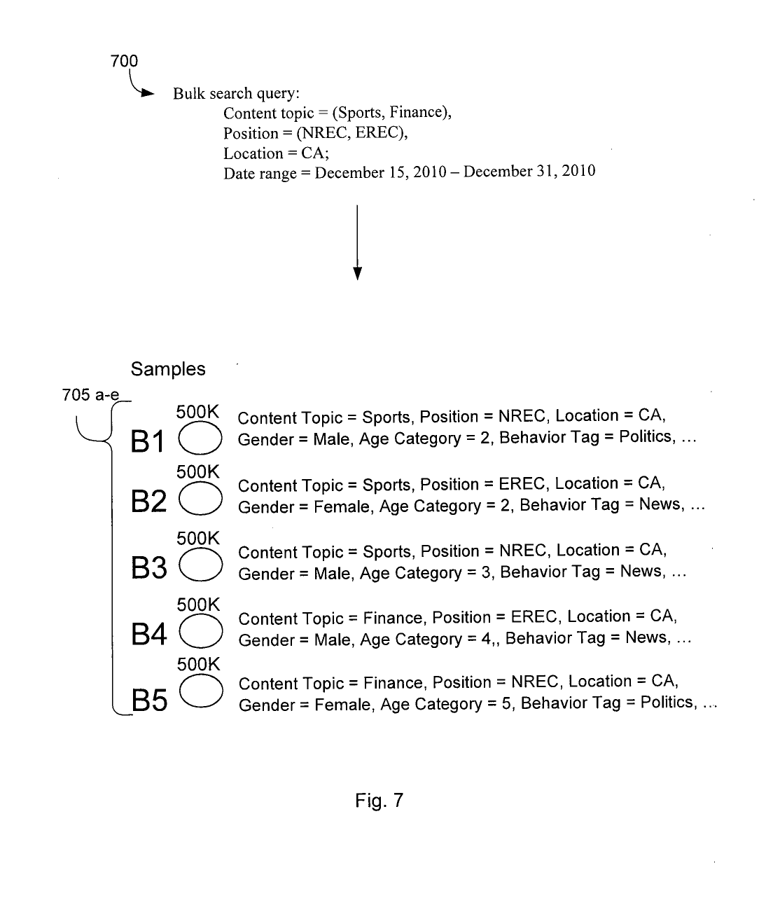

FIG. 6 illustrates exemplary operations that may performed by the inventory management system 100. The operations in FIG. 6 are best understood with reference to FIGS. 7-9. The operations performed may be different while still falling within the scope of the claims. Instructions for executing the operations may be stored in one or more non-transitory computer readable media. The instructions may be executed by any of the systems or processors described above.

At block 600, a search query may be received. For example, a web page for specifying targeting information such as the advertisement submission web page 200 may be communicated to an advertiser 170. The advertiser 170 may specify target values for various target categories. The information specified may be converted to a bulk query 700 (FIG. 7) that represents the various target values for the various target categories. The bulk query 700 may be generated by the AAS 105 and communicated to the optimizer module 120 and/or the supply forecasting system 110.

At block 605, one or more opportunity samples that match the bulk query are selected. For example, the supply forecasting system 110 may first select a number of sample opportunities that match the bulk query. The sample opportunities may be selected from the ad log database 135 or a different database. Each opportunity sample is associated with a weight that corresponds to a number of actual opportunities/impressions in the ad log database 135 with similar characteristics to those of the opportunity sample.

The number of samples selected may be limited to a certain quantity. For example, one thousand samples may be selected. The quantity may be set based on various factors including the amount of processing power available for determining available opportunity inventory and/or the expected response time for communicating the available opportunity inventory to an advertiser 170.

The bulk query is configured to cause the supply forecasting system 110 to select opportunities that match any combination of target values of the different target value categories rather than opportunities that match specific sub-combinations of the target values. In other words, rather than select, for example, 100 samples that match sub-combination 1, 100 samples that match sub-combination 2, etc., for a total of 100× the number of sub combinations, the bulk query is configured to cause the supply forecasting system 110 to select, for example, 100 total samples that match any combination of target values. This methodology decreases the number of samples that are subsequently processed, which improves the response time of the inventory management system 100.

However, the lower the number of samples, the less accurate the determination of the number of opportunities associated with a given sub-combination of target values. As noted above, the availability of future inventory is statistical in nature. The prediction of future inventory improves with an increased number of samples. Conversely, the prediction is less accurate when the number of samples is small. For example, it becomes difficult to determine the availability of future opportunities that match a particular sub-combination of target values when a small number of samples (e.g., 2 samples out of 100) match the sub-combination of target values. This problem is addressed in subsequent operations.

FIG. 7 illustrates exemplary samples 705a-e that match the bulk query 700 described above. That is, each sample 705a-e matches different combinations of the target values of the target categories. Each sample 705a-e has an associated weight that represents a number of opportunities. For example, a first sample 705a may represent 500,000 opportunities that correspond to males interested in politics that live in California and are expected to visit a sports web page and view or select an advertisement shown in a top rectangular region (i.e., NREC) of the web page. Similarly, a second sample 705b may represent 500,000 opportunities that correspond to females interested in news that live in California and are expected to visit a sports web page and view or select an advertisement shown in a left rectangular region (i.e., EREC) of the web page. Other samples 705c-e may be selected. The number of opportunities associated with a given sample may have been previously determined by, for example, periodically scanning the ad log database to generate different sample sets, where samples of a given set share one or more attributes.

At block 610, the number of opportunities of the selected samples 705a-e that are still available or unallocated to existing contracts may be determined. For example, data representing the selected samples 705a-e may be communicated to the AAS 105. The AAS 105 may then search the campaign log database 130 to determine whether any of the selected opportunities match existing contracts 805a-e in the campaign log database 130.

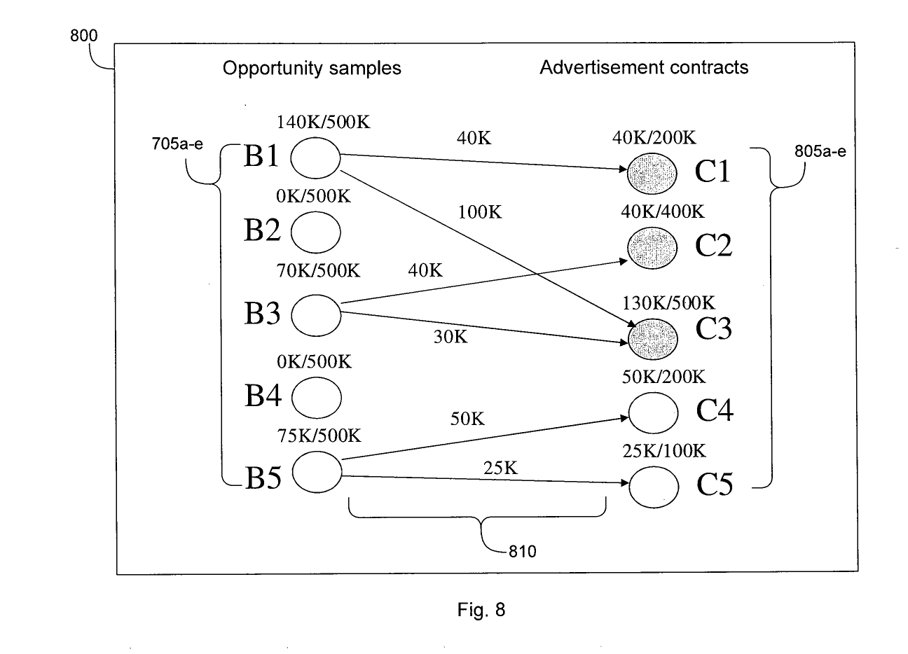

FIG. 8 is an exemplary graph 800 that illustrates the allocation of opportunities from opportunity samples 705a-e to existing advertisement contracts 805a-e. Shown are the opportunity samples B1-B5 705a-e selected at block 605 and a group of existing contracts C1-C5 805a-e. The lines 810 connecting the opportunity samples 705a-e to the contracts 805a-e represent opportunities allocated to a given contract 805a-e. The numbers above each opportunity sample 705a-e correspond to the number of allocated opportunities and the number of total opportunities (i.e., the weight) represented by the opportunity sample 705a-e. The numbers above the contracts 805a-e correspond to the number of contracted for opportunities satisfied from the opportunity samples 705a-e and the total number of contracted for opportunities specified by the contract. In the exemplary graph 800, 40,000 opportunities from opportunity sample B1 705a are determined to be allocated to contract C1 805a, and 100,000 opportunities are allocated to contract C3 805c. No opportunities are allocated from either opportunity sample B2 or B4 705bd. 40,000 opportunities from opportunity sample B3 705c are allocated to contract C2 805b, and 30,000 opportunities are allocated to contract C3 805c. 50,000 opportunities from opportunity sample B5 705e are allocated to contract C4 805d, and 25,000 opportunities are allocated to contract C5 805e.

Based on the foregoing allocations, the number of available opportunities from opportunity sample B1 705a is determined to be the difference between the 500,000 total opportunities represented by opportunity sample B1 705a and the 140,000 opportunities allocated to existing contracts 805a-e, or 360,000 available opportunities. Similarly, it is determined that the number of available opportunities for opportunity samples B2-B5 705b-e corresponds to 500,000, 430,000, 500,000, and 425,000, respectively.

At block 615, all the target value combinations of the bulk query are determined. For example, the AAS 105 may generate one or more sub-queries such as those shown in FIG. 3. In practice, the number of sub-query combinations may number in the tens or hundreds of combination depending on the number of target values specified by the advertiser 170. The number of target value combinations 305 may correspond to the number of permutations of the various target values from the target value categories.

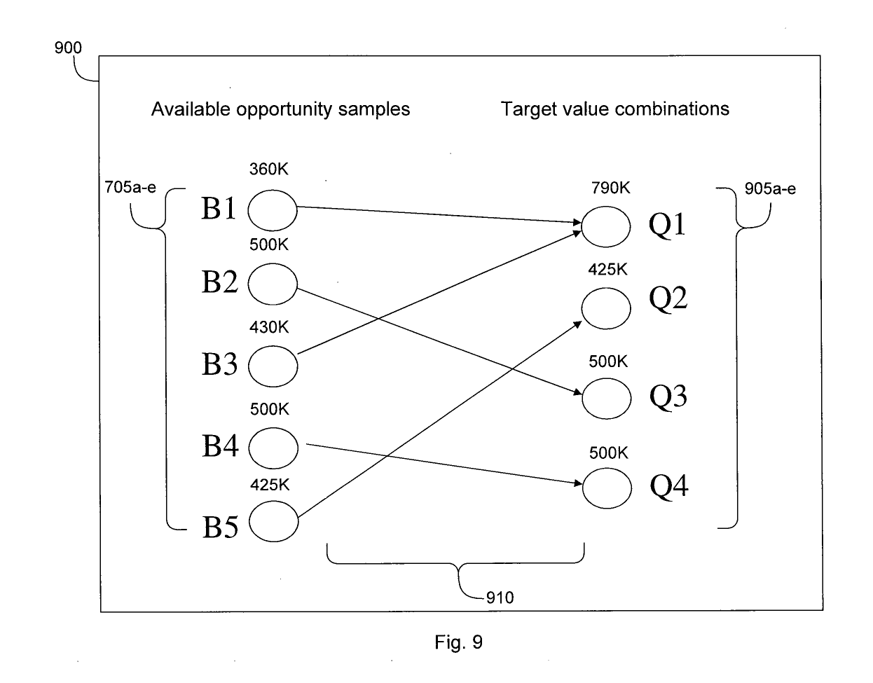

At block 620, the number of available opportunities that match the target value combinations is determined. FIG. 9 is an exemplary graph 900 that illustrates the allocation of available opportunities from opportunity samples 705a-e to target value combinations 905a-e. Shown are the opportunity samples B1-B5 705a-e selected at block 605 and the target value combinations or sub-queries 905a-e determined above. The lines 910 connecting the opportunity samples 705a-e to sub-queries Q1-Q4 905a-e (i.e., target value combinations 1-4) represent opportunity samples that match a given sub-query 905a-e. The numbers above each opportunity sample 705a-e correspond to the number of available opportunities. The numbers above the sub-queries 905a-e correspond to the number of available opportunities that match the sub-query. An opportunity from an opportunity sample 705a-e matches a sub-query 905a-e when the opportunity attributes match the target values of the sub-query 905a-e. In the exemplary graph 900, 360,000 available opportunities from opportunity sample B1 705a and 430,000 opportunities from opportunity sample B3 705c are determined to match sub-query Q1 905a. In other words, a total of 780,000 opportunities are determined to match sub-query Q1 905a. Similarly, 500,000 opportunities from opportunity sample B2 705b are available and match sub-query Q3 905c. 500,000 opportunities from opportunity sample B4 705d are available and match sub-query Q4 905d. 425,000 opportunities from opportunity sample B5 705e are available and match sub-query Q2 905b.

At block, 625, the target combinations and the number of available opportunities that match target combinations are communicated. For example, the exemplary result web page 300 (FIG. 3) may be communicated to the advertiser 170. The result web page 300 enables the advertiser 170 to quickly ascertain those target value combinations with the highest number of available opportunities.

At block 630, a selection of one or more of the target value combinations may be communicated. For example, the advertiser 170 may select desired target value combinations and the selection may be communicated to the AAS 105.

At block 635, the number of opportunities associated with the selected target combinations may be determined. The number of available opportunities may be determined in a similar manner as described in blocks 605-610. However, rather than the bulk query, one or more queries matching the various combinations of target values is generated. Then these queries are communicated to the supply forecasting system. The supply forecasting system 110 then selects one or more sample opportunities that match the one or more search queries. In other words, for each query, the forecasting system may search the ad log database 135 for opportunities (e.g., 100 opportunities) that match the query. The AAS 105 may then determine the amount of available inventory available from the returned samples.

As noted above, the accuracy of the prediction of future inventory improves with an increased number of samples. At step 605, however, the samples selected matched any combination of target values of the different target categories. The number of those samples that matched a specific sub-combination of the bulk query may have been relatively small resulting in a less accurate prediction of the number of available opportunities that match that sub-combination. However, at block 635 a relatively large number of samples that match the sub-combination are selected, thus providing a more accurate estimate of the number of available opportunities that match the sub-combination.

In some implementations, determination of the number of target value combinations at block 615 is performed after receiving the search query at block 600. Then, if the number of target combinations is below a threshold, samples that match each target combination are selected, and the available inventory associated with each of the selected samples is determined and communicated to the advertiser as described in blocks 630 and 635, respectively. If the number of target value combinations is greater than or equal to the threshold, then the operations continue from block 605.

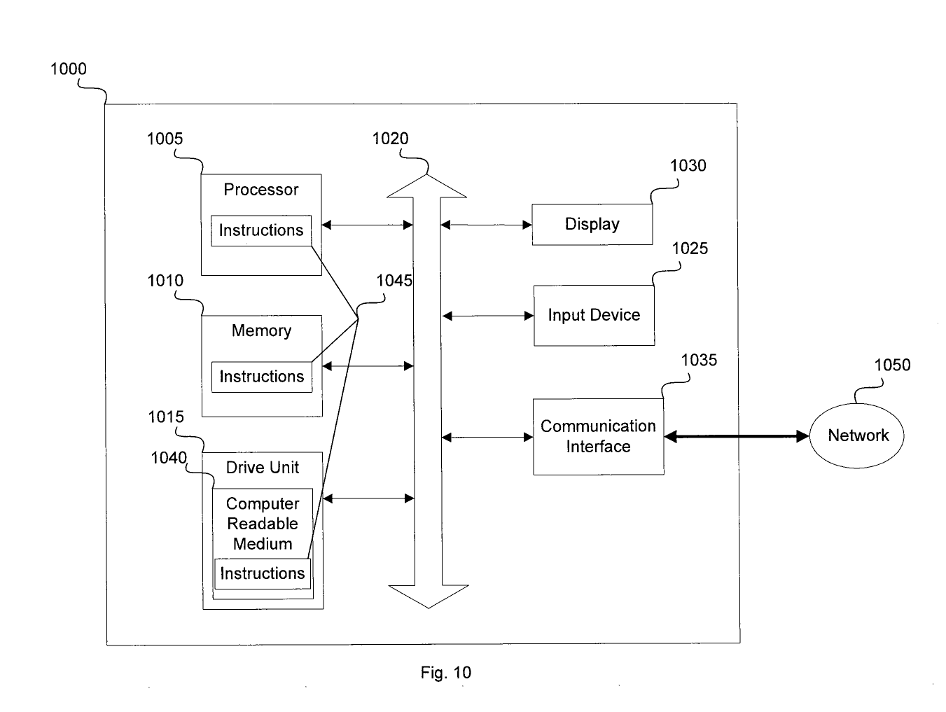

FIG. 10 illustrates a general computer system 1000, which may represent the AAS 105, the supply forecasting system 110, the optimizer 120, the ad server 115, or any other computing devices referenced herein. The computer system 1000 may include a set of instructions 1045 that may be executed to cause the computer system 1000 to perform any one or more of the methods or computer-based functions disclosed herein. The computer system 1000 may operate as a stand-alone device or may be connected, e.g., using a network, to other computer systems or peripheral devices.

In a networked deployment, the computer system 1000 may operate in the capacity of a server or as a client-user computer in a server-client user network environment, or as a peer computer system in a peer-to-peer (or distributed) network environment. The computer system 1000 may also be implemented as or incorporated into various devices, such as a personal computer or a mobile device, capable of executing a set of instructions 1045 (sequential or otherwise) that specify actions to be taken by that machine. Further, each of the systems described may include any collection of sub-systems that individually or jointly execute a set, or multiple sets, of instructions to perform one or more computer functions.

The computer system 1000 may include one or more memory devices 1010 on a bus for communicating information, such as the campaign log database 130 (FIG. 1) and/or the ad log database 135. In addition, code operable to cause the computer system to perform any of the acts or operations described herein may be stored in the memory 1010. The memory 1010 may be a random-access memory, read-only memory, programmable memory, hard disk drive or any other type of memory or storage device.

The computer system 1000 may include a display 1030, such as a liquid crystal display (LCD), a cathode ray tube (CRT), or any other display suitable for conveying information. The display 1030 may act as an interface for the user to see the functioning of the processor 1005, or specifically as an interface with the software stored in the memory 1010 or in the drive unit 1015.

Additionally, the computer system 1000 may include an input device 1025, such as a keyboard or mouse, configured to allow a user to interact with any of the components of system 1000.

The computer system 1000 may also include a disk or optical drive unit 1015, such as the high-latency storage 110 (FIG. 1). The disk drive unit 1015 may include a computer-readable medium 1040 in which one or more sets of instructions 1045, e.g. software, can be embedded. Further, the instructions 1045 may perform one or more of the operations as described herein. The instructions 1045 may reside completely, or at least partially, within the memory 1010 and/or within the processor 1005 during execution by the computer system 1000. The memory 1010 and the processor 1005 also may include computer-readable media as discussed above.

The computer system 1000 may include a communication interface 1035 that enables communications via a network 1050. The network 1050 may include wired networks, wireless networks, or combinations thereof. The communication interface 1035 network may enable communications via any number of communication standards, such as 802.11, 802.12, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

As shown, the described system and operations advantageously enable the advertiser to determine the amount of available inventory associated with a bulk query. In particular, the system is configured so that the advertiser may specify a bulk query specifying many target values. Rather than provide an accurate estimate for each sub-combination of target values, which can be time-consuming and/or processor intensive for a large bulk query, the system instead returns a somewhat granular representation of the amount of available inventory for various sub-combinations of the bulk query. The system then communicates the granular information to the advertiser who may then select specific combinations for which more accurate information is desired. The system then processes the specific sub-combination to obtain a more accurate estimate for the selected sub-combination of target values.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A network based advertisement method, the method comprising:
receiving, via an advertisement admission system, a search query that specifies a plurality of target values that belong to different target categories;
determining a number of available opportunities with attributes that match at least one target value of each of the different target categories from a store of opportunities;
determining one or more target value combinations, wherein each target value combination includes at least one target value from each of the different target categories; and
determining a subset number of available opportunities from the determined number of available opportunities that match the one or more target value combinations.

2. The method according to claim 1, further comprising:
communicating information associated with the subset number of available opportunities and the one or more target value combinations via the advertisement admission system; and
receiving, via the advertisement admission system, information that defines a selection of one or more of the one or more target value combinations.

3. The method according to claim 2, further comprising:
determining a number of available opportunities with attributes that match the one or more selected target combinations from the store of opportunities.

4. The method according to claim 1, wherein determining the number of available opportunities further comprises:
selecting a number of sample opportunities with attributes that match the at least one target value of each of the different target categories, wherein each sample opportunity is associated with a weight that represents a number of opportunities; and
determining a number of opportunities associated with each sample opportunity that is allocated to existing advertisement contracts, to thereby determine the number of available opportunities associated with each sample opportunity.

5. A network based advertisement method, the method comprising:
receiving, via an advertisement admission system, a search query that specifies a plurality of target values that belong to different target categories;
determining a number of target value combinations, wherein each target value combination includes at least one target value from each of the different target categories;
if the number of target value combinations exceeds a threshold, determining a number of available opportunities with attributes that match at least one target value of each of the different target categories from a store of opportunities; and
determining a subset number of available opportunities from the determined number of available opportunities that match each target value combination.

6. The method according to claim 5, further comprising:
communicating information associated with the subset number of available opportunities and the target value combinations to the advertisement admission system if the number of subset target requirements exceeds the threshold; and
receiving, via the advertisement admission system, information that defines a selection of one or more of the target value combinations.

7. The method according to claim 5, further comprising:
if the number of target value combinations is equal to or lower than the threshold, for each target value combination, determining a number of available opportunities with attributes that match the target value combination from the store of opportunities.

8. The method according to claim 5, wherein determining a number of available opportunities further comprises:
selecting a number of sample opportunities with attributes that match the at least one target value of each of the different target categories, wherein each sample opportunity is associated with a weight that represents a number of opportunities; and
determining a number of opportunities associated with each sample that is allocated to existing advertisement contracts.

9. A network based advertisement system comprising:
a supply forecasting system configured to receive a search query that defines opportunity characteristics and to communicate data that defines one or more sample opportunities from a store of opportunities that match the search query, where an opportunity corresponds to a future advertisement impression, where an impression corresponds to the communication of an advertisement to a user, where each sample opportunity is associated with a weight that corresponds to a number of opportunities represented by the sample opportunity; and
an advertisement admission system configured to:
receive data that defines a plurality of target values that belong to different target categories for targeting advertisements to users;
communicate to the forecasting system a bulk search query configured to cause the forecasting system to select sample opportunities that match any combination of target values from the different target categories;
receive from the forecasting system data that defines one or more sample opportunities that match the bulk query;
determine one or more target value combinations, wherein each target value combination includes at least one target value from each of the different target categories; and
determine a number of available opportunities from the one or more sample opportunities that match the one or more target value combinations.

10. The network based advertisement system according to claim 9, wherein the advertisement admission system is further configured to:
communicate information associated with the number of available opportunities and the one or more target value combinations to an advertiser;
receive information that defines a selection of one or more of the one or more target value combinations; and
communicate one or more search queries associated with the one or more target value combinations to the supply forecasting system.

11. The network based advertisement system according to claim 10, wherein the supply forecasting system is further configured to communicate data that defines a number of sample opportunities that match the one or more queries from the store of opportunities to the advertisement admission system.

12. The network based advertisement system according to claim 9, wherein the advertisement admissions system is further configured to determine a number of opportunities of the one or more sample opportunities that is allocated to existing advertisement contracts to thereby determine the number of available opportunities.

13. A network based advertisement system comprising:
a supply forecasting system configured to receive a search query that defines opportunity characteristics and to communicate data that defines one or more sample opportunities from a store of opportunities that match the search query, where an opportunity corresponds to a future advertisement impression, where an impression corresponds to the communication of an advertisement to a user, where each sample opportunity is associated with a weight that corresponds to a number of opportunities represented by the sample opportunity; and
an advertisement admission system configured to:
receive data that defines a plurality of target values that belong to different target categories for targeting advertisements to users;
determine one or more target value combinations and a number of target value combinations, wherein each target value combination includes at least one target value from each of the different target categories;
wherein if the number of target value combinations is above a threshold, the advertisement admission system is further configured to:
communicate to the forecasting system a bulk search query configured to cause the forecasting system to select sample opportunities that match any combination of target values from the different target categories,
receive from the forecasting system data that defines one or more sample opportunities that match the bulk query, and
determine a number of available opportunities from the one or more sample opportunities that match the one or more target value combinations, and
wherein if the number of target value combinations is equal to or lower than the threshold, the advertisement admission system is further configured to:
communicate to the forecasting system one or more search queries, each search query being associated with each of the one or more target combinations,
receive from the forecasting system data that defines one or more sample opportunities that match each of the one or more search queries, and
determine a number of available opportunities of the one or more sample opportunities.

14. The network based advertisement system according to claim 13, wherein if the number of target value combinations is above the threshold, the advertisement admission system is further configured to:
communicate information associated with the number of available opportunities and the one or more target value combinations to an advertiser;
receive information that defines a selection of one or more of the one or more target value combinations; and
communicate one or more search queries associated with the one or more target value combinations to the supply forecasting system.

15. The network based advertisement system according to claim 14, wherein the supply forecasting system is further configured to communicate data that defines a number of sample opportunities that match the one or more queries from the store of opportunities to the advertisement admission system.

16. The network based advertisement system according to claim 13, wherein the advertisement admissions system is further configured to determine a number of opportunities of the one or more sample opportunities that is allocated to existing advertisement contracts to thereby determine the number of available opportunities.

17. A machine-readable storage medium having stored thereon a computer program comprising at least one code section for operating a networked based advertisement system, the at least one code section being executable by a machine for causing the machine to perform acts of:
receiving a search query that specifies a plurality of target values that belong to different target categories;
determining a number of available opportunities with attributes that match at least one target value of each of the different target categories from a store of opportunities;
determining one or more target value combinations, wherein each target value combination includes at least one target value from each of the different target categories; and
determining a subset number of available opportunities from the determined number of available opportunities that match the one or more target value combinations.

18. The machine-readable storage medium according to claim 17, wherein the at least one code section is executable by the machine for causing the machine to perform acts of:
communicating information associated with the subset number of available opportunities and the one or more target value combinations to an advertisement admission system; and
receiving information that defines a selection of one or more of the one or more target value combinations.

19. The machine-readable storage medium according to claim 18, wherein the at least one code section is executable by the machine for causing the machine to perform acts of:
determining a number of available opportunities with attributes that match the one or more selected target combinations from the store of opportunities.

20. The machine-readable storage medium according to claim 17, wherein the at least one code section is executable by the machine for causing the machine to perform acts of:
selecting a number of sample opportunities with attributes that match the at least one target value of each of the different target categories, wherein each sample opportunity is associated with a weight that represents a number of opportunities; and
determining a number of opportunities associated with each sample that is allocated to existing advertisement contracts.

21. A machine-readable storage medium having stored thereon a computer program comprising at least one code section for operating a networked based advertisement system, the at least one code section being executable by a machine for causing the machine to perform acts of:
receiving a search query that specifies a plurality of target values that belong to different target categories;
determining a number of target value combinations, wherein each target value combination includes at least one target value from each of the different target categories;
if the number of target value combinations exceeds a threshold, determining a number of available opportunities with attributes that match at least one target value of each of the different target categories from a store of opportunities; and
determining a subset number of available opportunities from the determined number of available opportunities that match each target value combination.

22. The machine-readable storage medium according to claim 21, wherein the at least one code section is executable by the machine for causing the machine to perform acts of:
communicating information associated with the subset number of available opportunities and the target value combinations to the advertisement admission system if the number of subset target requirements exceeds the threshold.

23. The machine-readable storage medium according to claim 21, wherein the at least one code section is executable by the machine for causing the machine to perform acts of:
receiving information that defines a selection of one or more of the target value combinations.

24. The machine-readable storage medium according to claim 21, wherein the at least one code section is executable by the machine for causing the machine to perform acts of:
selecting a number of sample opportunities with attributes that match the at least one target value of each of the different target categories, wherein each sample opportunity is associated with a weight that represents a number of opportunities; and
determining a number of opportunities associated with each sample that is allocated to existing advertisement contracts.
